(19) United States
(12) Patent Application Publication
(10) Pub. No.: US 2026/0285246 A1
(43) Pub. Date: Sep. 24, 2026

(54) WIRING MEMBER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroki MAEDA, Osaka (JP); Kinji TAGUCHI, Osaka (JP); Ryoma UEGAKI, Osaka (JP)

(21) Appl. No.: 19/167,842

(22) PCT Filed: Mar. 22, 2024
(86) PCT No.: PCT/JP2024/011280

§ 371 Date: Sep. 23, 2025

(30) Foreign Application Priority Data
Mar. 27, 2023 (JP) 2023-049341

(51) Int. Cl. B60R 16/023; B60R 16/02; H01B 7/08

(52) U.S. Cl. CPC B60R 16/023; B60R 16/0215; H01B 7/0846; H01B 7/0861

(57) ABSTRACT

A wiring member includes a first insulated wire and a second insulated wire for differential signal transmission, a base member, on which the first and second insulated wires are arranged in parallel while being held in contact with each other, a holding sheet for pressing the first and second insulated wires in mutually contacting directions while covering the first and second insulated wires on the base member, and a fixing portion for fixing the first and second insulated wires to the base member.

### TECHNICAL FIELD

The present disclosure relates to a wiring member.

### BACKGROUND

Patent Document 1 discloses a wiring member in which a twisted cable is fixed on a principal surface of a base member. In the wiring member described in Patent Document 1, intervals between a plurality of insulated wires constituting the twisted cable are easily kept constant by fixing the twisted cable to the base member.

Patent Document 2 discloses a wiring member in which a plurality of insulated wires are arranged on a principal surface of a sheet member. In the wiring member described in Patent Document 2, intervals between the plurality of insulated wires are easily kept constant by holding the plurality of insulated wires on the sheet member.

### PRIOR ART DOCUMENT

### Patent Document

Patent Document 1: JP 2020-036523 A
Patent Document 2: JP 2019-204743 A

### SUMMARY OF THE INVENTION

### Problems to be Solved

Even if a plurality of insulated wires for transmitting differential signals are arranged on a base member without being twisted each other, it is desired to easily keep intervals between the plurality of insulated wires constant.

Accordingly, it is aimed to easily keep intervals between a plurality of insulated wires for transmitting differential signals constant even if the plurality of insulated wires are arranged on a base member without being twisted each other.

### Means to Solve the Problem

The present disclosure is directed to a wiring member with a first insulated wire and a second insulated wire for differential signal transmission, a base member, the first and second insulated wires being arranged in parallel on the base member while being held in contact with each other, a holding sheet for pressing the first and second insulated wires in mutually contacting directions while covering the first and second insulated wires on the base member, and a fixing portion for fixing the first and second insulated wires to the base member.

### Effect of the Invention

According to the present disclosure, even if a plurality of insulated wires for transmitting differential signals are arranged on a base member without being twisted each other, intervals between the plurality of insulated wires are more easily kept constant.

### BRIEF DESCRIPTION OF THE DRAWINGS

FIG. 1 is a plan view showing a wiring member according to one embodiment.

FIG. 2 is a section along II-II of FIG. 1.

FIG. 3 is an enlarged view of a region Al of FIG. 2.

FIG. 4 is a diagram showing an arrangement example of the wiring member.

FIG. 5 is a diagram showing another arrangement example of the wiring member.

FIG. 6 is a section showing a modification of the wiring member.

FIG. 7 is a section showing a modification of a holding sheet.

### DETAILED DESCRIPTION TO EXECUTE THE INVENTION

### Description of Embodiments of Present Disclosure

First, embodiments of the present disclosure are listed and described.

The wiring member of the present disclosure is as follows.
(1) The wiring member of the present disclosure is provided with a first insulated wire and a second insulated wire for differential signal transmission, a base member, the first and second insulated wires being arranged in parallel on the base member while being held in contact with each other, a holding sheet for pressing the first and second insulated wires in mutually contacting directions while covering the first and second insulated wires on the base member, and a fixing portion for fixing the first and second insulated wires to the base member.

According to the wiring member configured as in (1), the first and second insulated wires arranged in parallel on the base member are easily kept in contact with each other by the holding sheet. In this way, even if the first and second insulated wires are arranged on the base member without being twisted each other, the interval between the first and second insulated wires is easily kept constant.
(2) In the wiring member of (1), a sheet-wound wiring body formed by winding the holding sheet around the first and second insulated wires may be arranged on the base member, and the holding sheet may be interposed between the first and second insulated wires and the base member. In the sheet-wound wiring body, a contact state of the first and second insulated wires is easily kept by a winding pressure when the base member is wound. Further, since the first and second insulated wires can be arranged on the base member after being formed into the sheet-wound wiring body, position shifts of the first and second insulated wires hardly occur when being arranged on the base member. In this way, the interval between the first and second insulated wires is more easily kept contact on the base member.
(3) In the wiring member of (1) or (2), the holding sheet may be an adhesive tape, and the adhesive tape may adhere to the first and second insulated wires. In this way, the first and second insulated wires can be fixed to the adhesive tape, which is the holding sheet, whereby the interval between the first and second insulated wires is more easily kept contact on the base member.
(4) In the wiring member of any one of (1) to (3) described above, the holding sheet may include a shield layer. In this way, the holding sheet can have a shielding function for the first and second insulated wires.
(5) In the wiring member of any one of (1) to (3) described above, the holding sheet may not include a shield layer. In this way, a cost increase of the holding sheet can be suppressed.
(6) In the wiring member of any one of (1) to (5) described above, a thickness of the holding sheet may be smaller than a diameter of the first insulated wire. In this way, a thickness of the wiring member can be reduced as compared to the case where a twisted cable, in which the first and second insulated wires are twisted each other, is arranged. Further, the thickness of the wiring member can be reduced due to the absence of a sheath as compared to the case where the twisted cable is provided with the sheath.
(7) In the wiring member of any one of (1) to (6) described above, the fixing portion may include a first fixing portion where the first and second insulated wires are fixed to the holding sheet and a second fixing portion where the holding sheet is fixed to the base member. In this way, the first and second insulated wires can be fixed to the base member via the holding sheet.
(8) In the wiring member of any one of (1) to (7) described above, a linear transmission member may be further provided which is arranged on the base member, and the holding sheet may not cover the linear transmission member. In this way, the enlargement of the holding sheet can be suppressed.

### Details of Embodiment of Present Disclosure

A specific example of a wiring member of the present disclosure is described below with reference to the drawings. Note that the present disclosure is not limited to these illustrations, but is represented by claims and intended to include all changes in the scope of claims and in the meaning and scope of equivalents.

### Embodiment

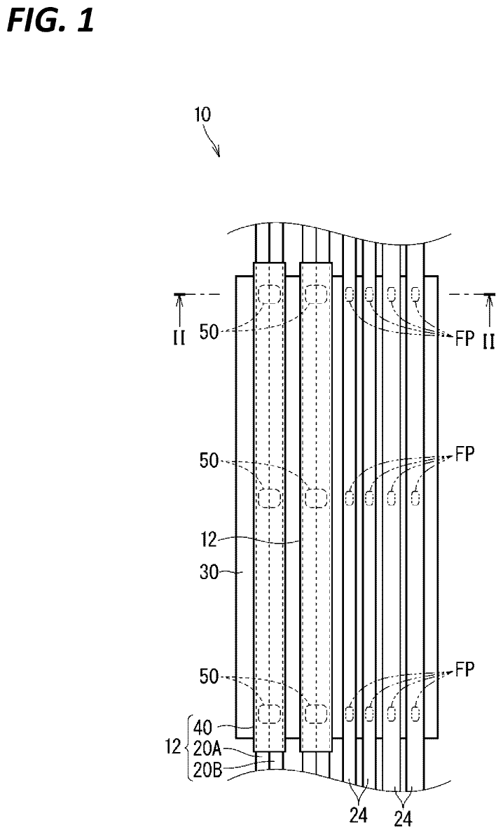

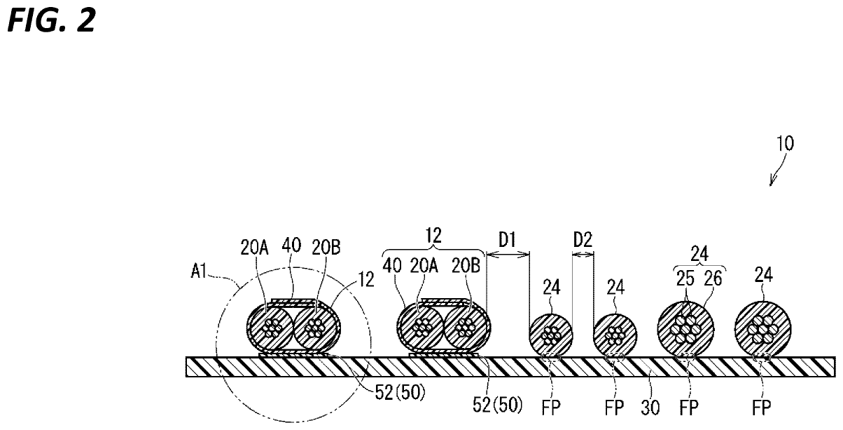

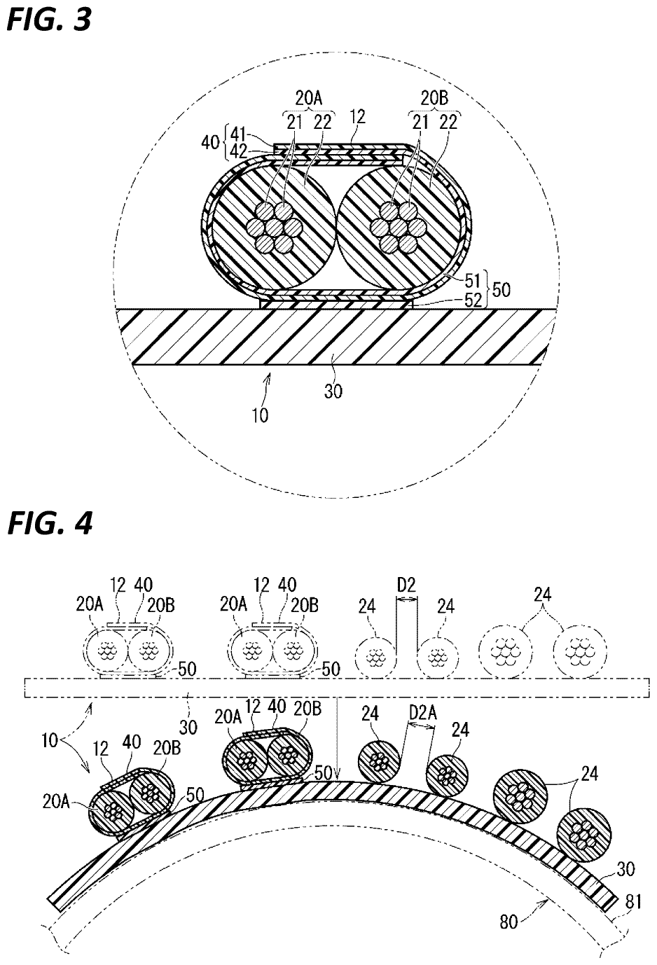

Hereinafter, a wiring member 10 according to one embodiment is described. FIG. 1 is a plan view showing the wiring member 10 according to the embodiment. FIG. 2 is a section along II-II of FIG. 1. FIG. 3 is an enlarged view of a region A1 of FIG. 2.

The wiring member 10 is provided with first insulated wires 20A, second insulated wires 20B, linear transmission members 24, a base member 30, holding sheets 40 and fixing portions 50. The first insulated wires 20A, the second insulated wires 20B and the linear transmission members 24 are arranged on the base member 30. The holding sheets 40 cover the first and second insulated wires 20A, 20B. The fixing portions 50 fix the first and second insulated wires 20A, 20B to the base member.

The first and second insulated wires 20A, 20B are used to transmit differential signals. The first and second insulated wires 20A, 20B are communication wires for in-vehicle high-speed communication. One or more pairs of the first and second insulated wires 20A, 20B are provided. In an example shown in FIG. 1, two pairs of the first and second insulated wires 20A, 20B are provided. Each insulated wire 20A, 20B includes a conductor core wire 21 and an insulation coating layer 22. The conductor core wire 21 includes one or more strands made of conductors. A plurality of the strands may constitute a stranded wire. The insulation coating layer 22 covers the periphery of the conductor core wire 21. For example, the insulation coating layer 22 is formed by extrusion-molding a resin around the conductor core wire 21. Each insulated wire 20A, 20B is a single wire having one conductive path. The first and second insulated wires 20A, 20B are arranged in parallel on the base member 30 while being held in contact with each other.

The linear transmission member 24 is a linear member for transmitting electricity, light or the like. For example, the linear transmission member 24 may be a wire for transmitting electricity or may be an optical fiber or the like for transmitting light. The linear transmission member 24 may include a transmission wire body 25 for transmitting electricity, light or the like and a coating layer 26 for covering the transmission wire body 25. If the linear transmission member 24 is a wire, a conductor core wire corresponds to the transmission wire body 25. If the linear transmission member 24 is an optical fiber, a core and a cladding correspond to the transmission wire body 25. If the linear transmission member 24 is a wire, such a wire may be a power wire for power supply or may be a signal wire for transmitting an electrical signal. If the linear transmission member 24 is a signal wire, the linear transmission member 24 may be a lower-speed communication wire than the first and second insulated wires 20A, 20B. The linear transmission member 24 may be thicker or thinner than the first and second insulated wires 20A, 20B. A thickness of the linear transmission member 24 may be equal to those of the insulated wires 20A, 20B. In the case of providing a plurality of the linear transmission members 24, the linear transmission members 24 having mutually different thicknesses may be provided.

The insulated wires 20A, 20B and the linear transmission members 24 connect components in a vehicle. Connectors are, for example, provided on end parts of the insulated wires 20A, 20B and the linear transmission members 24. The insulated wires 20A, 20B and the linear transmission members 24 may be connected to the same connectors or may be connected to mutually different connectors. By connecting the connector to a connector provided on a connection partner, the insulated wires 20A, 20B and the linear transmission members 24 are connected to the connection partner. That is, this wiring member 10 is used to electrically connect various components to each other in a vehicle or the like. In the example shown in FIG. 1, the end parts of the insulated wires 20A, 20B and the linear transmission members 24 extend outward from the base member 30. The end parts of the insulated wires 20A, 20B and the linear transmission members 24 may be arranged on the base member 30. The connector may be fixed to the base member 30.

Paths of the insulated wires 20A, 20B and the linear transmission members 24 are set according to the positions of components serving as connection destinations and the like. By fixing the insulated wires 20A, 20B and the linear transmission members 24 to the base member 30, the insulated wires 20A, 20B and the linear transmission members 24 are kept in a state along wiring paths corresponding to the positions of the components serving as the connection destinations thereof.

The base member 30 is in the form of a sheet. The plurality of insulated wires 20A, 20B and the plurality of linear transmission members 24 are kept side by side on the base member 30. The base member 30 is formed into a flat shape as a whole. The plurality of insulated wires 20A, 20B and the plurality of linear transmission members 24 are fixed to the base member 30, whereby the wiring member 10 is kept in a flat form.

Concerning a material for constituting the base member 30, the base member 30 is formed of a resin material here. A material other than a resin such as a metal or an inorganic matter may be used as the material for constituting the base member 30.

The structure of the base member 30 may be a single-layer structure or may be a multi-layer structure having two or more layers. The structure of layers in the base member 30 is not particularly limited. For example, the base member 30 may have a layer constituted by a sheet (also called as a non-foamed sheet, a solid sheet or the like) having a uninform solid cross-section. Further, for example, the base member 30 may have a layer constituted by a foamed sheet or the like. Further, for example, the base member 30 may have a layer constituted by a fiber material sheet such as a knitted fabric, a woven fabric and a nonwoven fabric.

The base member 30 may be a soft member. For example, the base member 30 may be flexible to be able to follow the bending of the wires and the linear transmission members 24. The wiring member 10 may be bendable (so bent that a fold extends along the principal surface of the base member 30) in a thickness direction.

The linear transmission member 24 may be fixed to the base member 30 and a structure for fixing the linear transmission member 24 to the base member 30 is not particularly limited. For example, the linear transmission member 24 is fixed to the base member 30. Such a fixing mode may be fixing at contact parts or non-fixing at contact parts, or both fixing modes may be used. Here, fixing at contact parts means that the linear transmission member 24 and the base member 30 are stuck and fixed at the contact parts. Further, non-fixing at contact parts is a fixing mode, which is not fixing at contact parts. For example, the linear transmission member 24 is pressed toward the base member 30 or the linear transmission member 24 and the base member 30 are sandwiched by a sewing thread, a cover, an adhesive tape or the like, and the linear transmission member 24 and the base member 30 are kept in such a state. In the following description, the linear transmission member 24 and the base member 30 are assumed to be fixed at contact parts.

Such a fixing mode at contact parts may be indirect fixing at contact parts or direct fixing at contact parts, or both modes may be used in different regions. Here, indirect fixing at contact parts means that the linear transmission member 24 and the base member 30 are indirectly stuck and fixed via an adhesive, a glue, a double-sided adhesive tape or the like provided therebetween. Further, direct fixing at contact parts means that the linear transmission member 24 and the base member 30 are directly stuck and fixed without via an adhesive or the like provided separately. In direct fixing at contact parts, the linear transmission member 24 and the base member 30 are thought to be stuck and fixed, for example, by melting a resin contained in at least one of the linear transmission member 24 and the base member 30.

In forming such a direct fixing state at contact parts, the resin is, for example, thought to be melted by heat or melted by a solvent. That is, the direct fixing state at contact parts may be a direct fixing state at contact parts by heat or a direct fixing state at contact parts by the solvent. Preferably, the direct fixing state at contact parts by heat may be adopted.

A means for forming the direct fixing state at contact parts at this time is not particularly limited and a known means such as welding and fusion can be used. For example, in the case of forming the direct fixing state at contact parts by heat through welding, various welding means such as ultrasonic welding, heat and pressure welding, hot air welding and high frequency welding can be adopted. If the direct fixing state at contact parts is formed by one of these means, the linear transmission member 24 and the base member 30 are in the direct fixing state at contact parts by that means. Specifically, if the direct fixing state at contact parts is formed by ultrasonic welding, the linear transmission member 24 and the base member 30 are in the direct fixing state at contact parts by ultrasonic welding.

In the following description, the linear transmission member 24 and the base member 30 are assumed to be in the direct fixing state at contact parts.

If the linear transmission member 24 and the base member 30 are in the direct fixing state at contact parts, the base member 30 may have a double-layer structure including a first layer and a second layer. The first layer is a fixed layer. The coating layer 26 of the linear transmission member 24 is directly fixed to the fixed layer at the contact parts. The fixed layer contains a resin material, preferably a thermoplastic resin material. The resin material of the fixed layer is softened and directly fixed to a fixing partner at contact parts. The type of such a resin material is not particularly limited and polyvinyl chloride (PVC), polyethylene (PE), polypropylene (PP), polyethylene terephthalate (PET) and the like can be adopted. The coating layer 26 may also contain the same resin material as the fixed layer. One surface of the first layer is one principal surface of the base member 30.

The second layer is an additional layer. The second layer is made of a material different from the fixed layer or has a structure different from the fixed layer. The second layer enhances a function of the fixed layer or adds a function not achieved by the fixed layer to the base member 30. A material for constituting the second layer may be a metal, an inorganic matter or the like besides the materials described for the fixed layer. One surface of the second layer is the other principal surface of the base member 30.

The first and second layers are fixed while the other surface of the first layer and that of the second layer are held in contact. A fixing mode of the first and second layers is not particularly limited, but may be directly or indirectly fixed at contact parts. For example, if at least one of the first and second layers is a sheet having gaps in surfaces such as a fiber material sheet or a foamed sheet, a resin material or an adhesive can enter the gaps and be fixed. In this way, a so-called anchoring effect is exhibited and the first and second layers are firmly fixed.

Here, the first layer is described as a solid sheet and the second layer is described as a fiber material sheet. Here, the first and second layers are described to be directly fixed at contact parts. That is, the resin of the first layer in a fluidal state enters between fibers of the second layers and is cured. In this way, a state where the resin of the first layer is located between the fibers in the second layer is maintained and the first and second layers are firmly fixed.

The first and second layers may be formed to have the same size (same planar shape). One of the first and second layers may be formed to be larger than the other. The first and second layers are entirely fixed in contact regions. The first and second layers may be fixed only in parts of the contact regions. For example, the first layer may be a solid sheet made of soft resin such as soft PVC, the second layer may be a nonwoven fabric made of PET and the base member 30 may be a soft member.

Each of the plurality of linear transmission members 24 is fixed to the base member 30 at a plurality of positions spaced apart in a longitudinal direction. In FIGS. 1 and 2, fixed positions FP of each of the plurality of linear transmission members 24 and the base member 30 are indicated by two-dot chain lines.

In the wiring member 10, the plurality of linear transmission members 24 are fixed to the base member 30 at the same positions along the longitudinal direction. In the wiring member 10, the plurality of linear transmission members 24 may be fixed to the base member 30 at different positions along the longitudinal direction. In one linear transmission member 24, intervals between the plurality of fixed positions FP may be equal or may be different.

The holding sheet 40 presses the first and second insulated wires 20A, 20B in mutually contacting directions while covering the first and second insulated wires 20A, 20B on the base member 30. Parts of the first and second insulated wires 20A, 20B in contact with each other are not fixed at the contact parts. The first and second insulated wires 20A, 20B are restricted from moving in directions separating from each other by the holding sheet 40.

A state where the base member 30 is flat to spread along a plane as shown in FIG. 2 and no external force is applied to the first and second insulated wires 20A, 20B is a reference state. In the reference state, a force acting toward the second insulated wire 20B may be applied from the holding sheet 40 to a half part of the first insulated wire 20A from a center on a side opposite to the second insulated wire 20B. In the reference state, a force acting toward the second insulated wire 20B may be applied from the holding sheet 40 to a surface on a side opposite to the part in contact with the second insulated wire 20B, out of the outer surface of the first insulated wire 20A. No force may be applied to the first insulated wire 20A from the holding sheet 40 in the reference state, and the holding sheet 40 may restrict a movement of the first insulated wire 20A when the base member 30 is bent or an external force is applied to the first insulated wire 20A so that the first insulated wire 20A moves in the direction separating from the second insulated wire 20B.

In the reference state, a force acting toward the first insulated wire 20A may be applied from the holding sheet 40 to a half part of the second insulated wire 20B from a center on a side opposite to the first insulated wire 20A. In the reference state, a force acting toward the first insulated wire 20A may be applied from the holding sheet 40 to a surface on a side opposite to the part in contact with the first insulated wire 20A, out of the outer surface of the second insulated wire 20B. No force may be applied to the first insulated wire 20A from the holding sheet 40 in the reference state, and the holding sheet 40 may restrict a movement of the second insulated wire 20B when the base member 30 is bent or an external force is applied to the second insulated wire 20B so that the second insulated wire 20B moves in the direction separating from the first insulated wire 20A.

A sheet-wound wiring body 12 formed by winding the holding sheet 40 around the first and second insulated wires 20A, 20B is arranged on the base member 30. The holding sheet 40 covers the first and second insulated wires 20A, 20B entirely along a circumferential direction. Therefore, the holding sheet 40 is interposed also between the first and second insulated wires 20A, 20B and the base member 30.

Two pairs of the first and second insulated wires 20A, 20B are respectively wound by different holding sheets 40. Accordingly, two sheet-wound wiring bodies 12 are arranged on the base member 30. The two sheet-wound wiring bodies 12 are arranged apart from each other. The two sheet-wound wiring bodies 12 may be so arranged that the holding sheets 40 thereof are in contact. No linear transmission member 24 is arranged between the two sheet-wound wiring bodies 12. The linear transmission member(s) 24 may be arranged between the two sheet-wound wiring bodies 12.

The holding sheet 40 is provided over the entire length in sections of the first and second insulated wires 20, 20B on the base member 30. In this case, it is better to provide the holding sheet 40 such that the first and second insulated wires 20A, 20B are not exposed from the holding sheet 40. For example, the holding sheet 40 in the form of an elongated strip may be wound on the insulated wires 20A, 20B. The holding sheet 40 may be, for example, wound in such a manner that edge parts along a longitudinal direction of the holding sheet 40 extend along the longitudinal direction of the insulated wires 20A, 20B (also called longitudinal support). Further, the holding sheet 40 may be, for example, wound in such a manner that the edge parts along the longitudinal direction of the holding sheet 40 are helically present around the insulated wires 20A, 20B (also called helical winding). In the case of helical winding, the holding sheet 40 may be so wound that parts thereof overlap (also called wrap winding).

The holding sheets 40 may be provided at a plurality of positions spaced apart along the longitudinal direction of the section of the first and second insulated wires 20A, 20B on the base member 30. The first and second insulated wires 20A, 20B may be exposed between the holding sheets 40. In this case, the holding sheet 40 may be, for example, wound in such a manner that the edge parts along the longitudinal direction of the holding sheet 40 extend along a circumferential direction of the insulated wires 20A, 20B. Further, helical winding may be, for example, such that the parts of the holding sheet 40 do not overlap (also called rough winding or the like).

The sheet-wound wiring body 12 extends outward from the base member 30. Parts of the first and second insulated wires 20A, 20B extending outward from edge parts of the base member 30 are also wound by the holding sheet 40. The sheet-wound wiring body 12 may not extend outward from the base member 30. The holding sheet 40 may be wound only on parts of the first and second insulated wires 20A, 20B located on the base member 30.

Here, the holding sheet 40 is an adhesive tape 40. The adhesive tape 40 adheres to the first and second insulated wires 20A, 20B. The adhesive tape 40 includes a base material layer 41 and an adhesive layer 42. Here, the holding sheet 40 does not include a shield layer. The adhesive layer 42 adheres to the first and second insulated wires 20A, 20B. The base material layer 41 appears on the outer surface of the sheet-wound wiring body 12.

A thickness of the holding sheet 40 is not particularly limited and can be appropriately set. For example, the thickness of the holding sheet 40 may be smaller than a diameter of the first insulated wire 20A or may be smaller than a thickness of the base member 30. For example, the diameter of each insulated wire 20A, 20B is about 0.1 mm to 2.0 mm, and the thickness of the holding sheet 40 may be smaller than that. If the holding sheet 40 is wound entirely around the first and second insulated wires 20A, 20B to form the sheet-wound wiring body 12, the thickness of the holding sheet 40 is smaller than a radius of the first insulated wire 20A. A thickness of the sheet-wound wiring body 12 (a vertical dimension in FIG. 2) is smaller than the sum of the diameter of the first insulated wire 20A and that of the second insulated wire 20B.

Further, in this embodiment, the holding sheet 40 does not cover the linear transmission members 24. A surface of the linear transmission member 24 facing a side opposite to the base member 30 is exposed.

The fixing portion 50 fixes the first and second insulated wires 20A, 20B to the base member 30. Here, the fixing portion 50 includes a first fixing portion 51 and a second fixing portion 52. The first fixing portion 51 is a part where the first and second insulated wires 20A, 20B are fixed to the holding sheet 40. The second fixing portion 52 is a part where the holding sheet 40 is fixed to the base member 30. Accordingly, the first and second insulated wires 20A, 20B are fixed to the base member 30 via the holding sheet 40. The first and second insulated wires 20A, 20B and the holding sheet 40 are formed into the sheet-wound wiring body 12 by the first fixing portion 51. The sheet-wound wiring body 12 is fixed to the base member 30 by the second fixing portion 52. Here, the first fixing portion 51 is a part where the adhesive tape 40 is adhered to the first and second insulated wires 20A, 20B. Further, the second fixing portion 52 is an adhesive provided between the adhesive tape 40 and the base member 30 here.

Of course, the first and second fixing portions 51, 52 are not limited to those described above. A fixing mode of the first fixing portion 51 and that of the second fixing portion 52 can be appropriately selected from the fixing modes of the base member 30 and the linear transmission member 24. For example, the holding sheet 40 and the base member 30 may be directly fixed at contact parts. If the holding sheet 40 is the adhesive tape 40, the base material layer 41 and the base member 30 may be directly fixed at contact parts. A part between the insulated wires 20A, 20B and the base member 30, out of the adhesive tape 40, may be directly fixed to the base member 30 at the contact parts. An adhesive tape different from the adhesive tape 40 shown in FIG. 2 may be provided to sandwich the sheet-wound wiring body 12 shown in FIG. 2, and a part projecting laterally of the sheet-wound wiring body 12, out of the adhesive tape 40, may be directly fixed to the base member 30 at the contact parts.

The fixing portions 50 are provided at a plurality of positions spaced apart along the longitudinal direction of the insulated wires 20A, 20B. The fixing portion 50 may be continuously provided over an entire length along the longitudinal direction of the insulated wires 20A, 20B. The fixing portion 50 is provided laterally to a fixed position. The fixing portion 50 and the fixed position may be provided at positions separated from each other along the longitudinal direction of the base member 30.

By pressing the first and second insulated wires 20A, 20B by the holding sheet 40, a contact state of the first and second insulated wires 20A, 20B is satisfactorily kept. The first and second insulated wires 20A, 20B extend while spreading on the base member 30 without overlapping each other in the thickness direction of the base member 30 in a straight section.

On the base member 30, the first and second insulated wires 20A, 20B and the linear transmission members 24 are arranged apart from each other. An interval D1 shown in FIG. 2 is the smaller one of an interval between the first insulated wire 20A and the linear transmission member 24 and an interval between the second insulated wire 20B and the linear transmission member 24 on the base member 30.

On the base member 30, the linear transmission members 24 are arranged apart from each other. An interval D2 shown in FIG. 2 is an example of the interval D2 between the linear transmission members 24 on the base member 30. The interval D2 may be, for example, smaller than the interval D1.

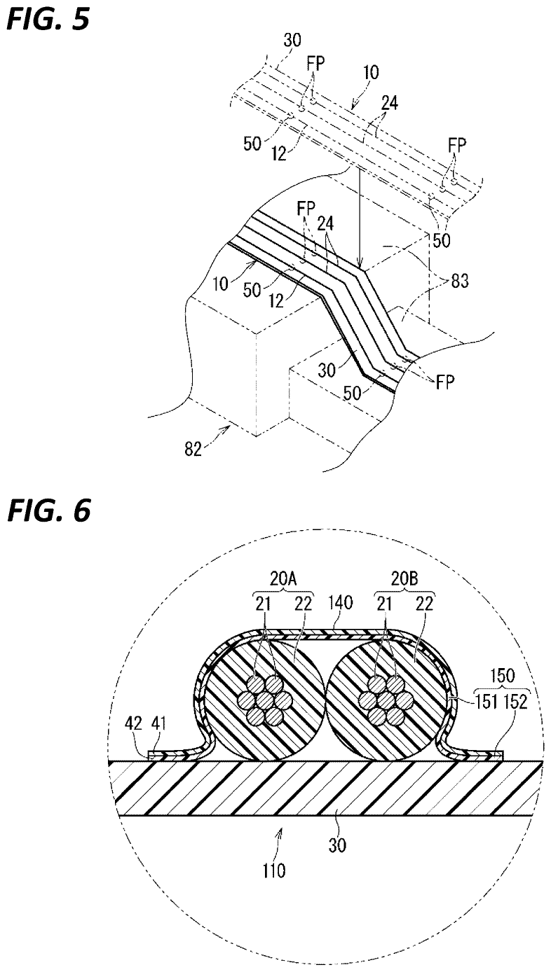

FIG. 4 is a diagram showing an example in which the wiring member 10 is arranged on an arrangement target 80. FIG. 5 is a diagram showing an example in which the wiring member 10 is arranged on an arrangement target 82 different from the arrangement target 80. In FIG. 5, each of the sheet-wound wiring bodies 12 and the linear transmission members 24 is shown by one line.

The wiring member 10 may be arranged on the arrangement target 80, 82 by being curved or bent. The arrangement targets 80, 82 are various members in a vehicle. For example, the arrangement targets 80, 82 may be an exterior panel, a vehicle body frame, an interior member and the like. The exterior panel is, for example, a member forming the outer appearance of the vehicle such as a door panel or a roof panel. The vehicle body frame is a member forming a framework of the vehicle. The vehicle body frame includes a reinforcement and the like. The interior member is, for example, a member forming the internal appearance of the vehicle such as an instrument panel, a door trim or a roof trim. The arrangement targets 80, 82 are shaped in conformity with various members. The arrangement targets 80, 82 may be, for example, formed into a rod shape or a plate shape.

Here, the arrangement target 80, 82 has an arrangement surface 81, 83. The wiring member 10 is arranged along the arrangement surface 81, 83. The arrangement surface 81, 83 has a non-straight surface. Such a non-straight surface may be a curved surface or may be a bent surface. The wiring member 10 can be arranged by being curved or bent along the non-straight surface.

In an example shown in FIG. 4, the wiring member 10 is arranged on the arrangement surface 81 curved about an axis along the longitudinal direction. In the base member 30, a surface on which the insulated wires 20A, 20B and the linear transmission members 24 are arranged is located on an outer peripheral side. In this case, as shown in FIG. 4, an interval D2A between the linear transmission members 24 possibly becomes larger than the interval D2 between the linear transmission members 24 in the reference state as the base member 30 is curved. In contract, since the first and second insulated wires 20A, 20B are pressed by the holding sheet 40, the first and second insulated wires 20A, 20B are restricted from moving in directions separating from each other and kept in a contact state.

Further, in an example shown in FIG. 5, the wiring member 10 is arranged on the arrangement surface 83 by being bent about an axis along the width direction. A step is formed in the arrangement surface 83, and the wiring member 10 can be regarded as riding over this step. In the wiring member 10, the insulated wires 20A, 20B and the linear transmission members 24 are fixed to the base member 30 at intervals in the longitudinal direction. In this case, the individual linear transmission members 24 can be freely bent with respect to each other in a bending range along the bending of the base member 30 in sections of the linear transmission members 24 between the fixed positions. Thus, the sections of the linear transmission members 24 between the fixed positions are roughly bent similarly to the base member 30 as the base member 30 is bent, but may not have exactly the same bent shape. In this case, the intervals between the linear transmission members 24 possibly change. In contrast, the first and second insulated wires 20A, 20B are pressed by the holding sheet 40, thereby being able to be bent into the same shape also in sections between the fixing portions 50. In this way, the contact state of the first and second insulated wires 20A, 20B is kept also in the sections between the fixing portions 50.

### <Effects, Etc. >

According to the wiring member 10 configured as described above, the first and second insulated wires 20A, 20B arranged in parallel on the base member 30 are easily held in contact with each other by the holding sheet 40. In this way, even if the first and second insulated wires 20A, 20B are arranged on the base member 30 without being twisted each other, the interval between the first and second insulated wires 20A, 20B is more easily kept constant. Further, if the wiring member 10 is arranged by being curved or bent as shown in FIG. 4 or 5, the contact state of the first and second insulated wires 20A, 20B is easily kept by the holding sheet 40. By keeping the contact state of the first and second insulated wires 20A, 20B over the entire lengths on the base member 30, characteristic impedances of the first and second insulated wires 20A, 20B are stabilized and a path length difference is hardly generated between the first and second insulated wires 20A, 20B. In this way, in the first and second insulated wires 20A, 20B for differential transmission, more stable high-speed communication becomes possible.

Here, the speed-up of in-vehicle communication is desired in the vehicle according to an increase in transmission data amount and the like. In-vehicle Ethernet (registered trademark) is known as one of in-vehicle communication standards capable of high-speed transmission. TC2 (Technical Committees 2) of the Open Alliance represents transmission characteristics to be satisfied by wires and the like to achieve 100BASE-T1, which is one of standards of the in-vehicle Ethernet (registered trademark). High-speed communication lines by the first and second insulated wires 20A, 20B in the wiring member 10 of the present disclosure satisfy the transmission characteristics in TC2 of the Open Alliance by being arranged on the base member 30 using the holding sheet 40 even without being formed into a twisted cable. That is, the high-speed communication lines by the first and second insulated wires 20A, 20B in the wiring member 10 of the present disclosure have high-speed communication performance equivalent to 100BASE-T1.

Further, the sheet-wound wiring body 12 is arranged on the base member 30. In the sheet-wound wiring body 12, the contact state of the first and second insulated wires 20A, 20B is easily kept by a winding pressure when the base member 30 is wound. Further, the first and second insulated wires 20A, 20B can be arranged on the base member 30 after being formed into the sheet-wound wiring body 12, whereby position shifts of the first and second insulated wires 20A, 20B hardly occur when the first and second insulated wires 20A, 20B are arranged on the base member 30. By these, the interval of the first and second insulated wires 20A, 20B on the base member 30 is more easily kept constant.

Further, the adhesive tape 40 serving as the holding sheet 40 adheres to the first and second insulated wires 20A, 20B. In this way, the first and second insulated wires 20A, 20B can be fixed to the adhesive tape 40 serving as the holding sheet 40, whereby the interval of the first and second insulated wires 20A, 20B on the base member 30 is more easily kept constant.

Further, the holding sheet 40 does not include a shield layer 243. In this way, a cost increase of the holding sheet 40 can be suppressed.

Further, the thickness of the holding sheet 40 is smaller than the diameter of the first insulated wire 20A. In this way, a thickness of the wiring member 10 can be reduced as compared to the case where a twisted cable, in which the first and second insulated wires 20A, 20B are twisted each other, is arranged. Further, the thickness of the wiring member 10 can be reduced due to the absence of a sheath as compared with the case where a twisted cable is provided with the sheath.

Further, the fixing portion 50 includes the first fixing portion 51 where the first and second insulated wires 20A, 20B are fixed to the holding sheet 40 and the second fixing portion 52 where the holding sheet 40 is fixed to the base member 30. In this way, the first and second insulated wires 20A, 20B can be fixed to the base member 30 via the holding sheet 40.

Further, the holding sheet 40 does not cover the linear transmission members 24. In this way, the enlargement of the holding sheet 40 can be suppressed.

### Additional Statement

FIG. 6 is a section showing a modification of the wiring member 10.

In a wiring member 110 shown in FIG. 6, a holding sheet 140 is not wound around the first and second insulated wires 20A, 20B. The first and second insulated wires 20A, 20B are in contact with the base member 30 on a side opposite to the holding sheet 140. Even in this case, if the holding sheet 140 presses the first and second insulated wires 20A, 20B in mutually contacting directions, the contact state of the first and second insulated wires 20A, 20B can be kept.

A fixing portion 150 in the wiring member 110 includes a first fixing portion 151 and a second fixing portion 152. The first fixing portion 151 is a part where an adhesive tape 140 is adhered to the first and second insulated wires 20A, 20B, similarly to the first fixing portion 51 of the wiring member 10. The second fixing portion 152 is a part where the adhesive tape 140 is adhered to the base member 30, unlike the second fixing portion 52 of the wiring member 10. In this case, the first and second insulated wires 20A, 20B can be fixed to the base member 30 by one holding sheet 140.

A part constituting the second fixing portion 152, out of the adhesive tape 140, extends laterally from a part constituting the first fixing portion 151. Thus, the part constituting the first fixing portion 151, out of the adhesive tape 140, is adhered to the first and second insulated wires 20A, 20B in a smaller range than the part constituting the first fixing portion 51, out of the adhesive tape 40. In this case, the part constituting the first fixing portion 151, out of the adhesive tape 140, may be adhered to a region below centers of the respective insulated wires 20A, 20B. In this way, the adhesive tape 140 can more firmly press the first and second insulated wires 20A, 20B in the mutually contacting directions.

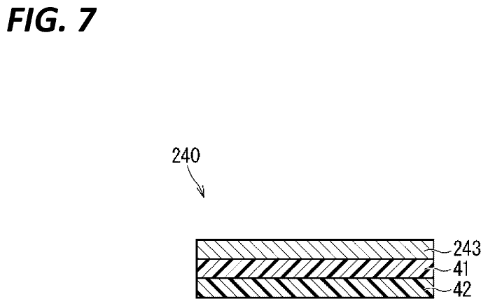

FIG. 7 is a section showing a modification of the holding sheet 40.

A holding sheet 240 shown in FIG. 7 includes a shield layer 243. In this way, the holding sheet 240 can have a shielding function for the first and second insulated wires 20A, 20B. For example, the holding sheet 240 is an adhesive tape 240 including the shield layer 243 in addition to a base material layer 41 and an adhesive layer 42. The shield layer 243 may be, for example, a layer made of a conductor or may be an electrically conductive resin layer. The layer made of a conductor may be a layer obtained by adhering a conductive foil to the base material layer 41 or may be a layer obtained by depositing a conductor on the base material layer 41. In the adhesive tape 240, the base material layer 41 may be omitted and the adhesive layer 42 may be provided on the shield layer 243. The holding sheet 240 may be a sheet other than the adhesive tape 240 and including the shield layer 243.

Besides, although the holding sheet 40 has been described as the adhesive tape 40 thus far, this is not essential. The holding sheet may be a sheet other than the adhesive tape 40 and may be one of various sheets described in the above layer structure of the base member 30. Further, the holding sheet may be a self-adhesive tape.

Further, although the fixing portion 50 has been described to include the first fixing portion 51 where the first and second insulated wires 20A, 20B are fixed to the holding sheet 40 and the second fixing portion 52 where the holding sheet 40 is fixed to the base member 30 thus far, this is not essential. The first and second insulated wires 20A, 20B may be fixed to the base member 30, separately from the holding sheet 40. Further, the holding sheet 40 may not be directly fixed to the base member 30 and may be fixed to the base member 30 via the first and second insulated wires 20A, 20B.

Further, although the holding sheet 40 has been described not to cover the linear transmission members 24 thus far, this is not essential. The linear transmission members 24 may also be covered by the holding sheet 40. Further, although the wiring member 10 has been described to include the linear transmission members 24 thus far, this is not essential. The wiring member 10 may not be provided with the linear transmission members 24.

Note that the respective configurations described in the above embodiment and each modification can be combined as appropriate without contradicting each other.

### LIST OF REFERENCE NUMERALS

10 wiring member
12 sheet-wound wiring body
20A first insulated wire
20B second insulated wire
21 conductor core wire
22 insulating coating layer
24 linear transmission member
25 transmission wire body
26 coating layer
30 base member
40, 140, 240 adhesive tape (holding sheet)
41 base material layer
42 adhesive layer
50, 150 fixing portion
51, 151 first fixing portion
52, 152 second fixing portion
80, 82 arrangement target
81, 83 arrangement surface
243 shield layer
D1, D2 interval
FP fixed position

1. A wiring member, comprising:
a first insulated wire and a second insulated wire for differential signal transmission;
a base member, the first and second insulated wires being arranged in parallel on the base member while being held in contact with each other;
a holding sheet for pressing the first and second insulated wires in mutually contacting directions while covering the first and second insulated wires on the base member; and
a fixing portion for fixing the first and second insulated wires to the base member.

2. The wiring member of claim 1, wherein:
a sheet-wound wiring body formed by winding the holding sheet around the first and second insulated wires is arranged on the base member, and
the holding sheet is interposed between the first and second insulated wires and the base member.

3. The wiring member of claim 1, wherein:
the holding sheet is an adhesive tape, and
the adhesive tape adheres to the first and second insulated wires.

4. The wiring member of claim 1, wherein the holding sheet includes a shield layer.

5. The wiring member of claim 1, wherein the holding sheet does not include a shield layer.

6. The wiring member of claim 1, wherein a thickness of the holding sheet is smaller than a diameter of the first insulated wire.

7. The wiring member of claim 1, wherein the fixing portion includes a first fixing portion where the first and second insulated wires are fixed to the holding sheet and a second fixing portion where the holding sheet is fixed to the base member.

8. The wiring member of claim 1, further comprising a linear transmission member arranged on the base member, wherein:
the holding sheet does not cover the linear transmission member.
